(19) United States
(12) Patent Application Publication
(10) Pub. No.: US 2013/0145191 A1
(43) Pub. Date: Jun. 6, 2013

(54) UNIVERSAL SERIAL BUS DEVICE AND METHOD FOR POWER MANAGEMENT

(71) Applicants: Wei-Cheng Hung, Hsinchu (TW); Chun-Chi Chu, Hsinchu (TW); Kuang Ming Tseng, Hsinchu (TW)

(72) Inventors: Wei-Cheng Hung, Hsinchu (TW); Chun-Chi Chu, Hsinchu (TW); Kuang Ming Tseng, Hsinchu (TW)

(21) Appl. No.: 13/366,079

(22) Filed: Feb. 3, 2012

(30) Foreign Application Priority Data
Dec. 5, 2011 (TW) 100144572

(51) Int. Cl. G06F 1/32

(52) U.S. Cl. 713/323

(57) ABSTRACT

The present invention discloses a Universal Serial Bus (“USB”) device with a power saving mechanism. The USB device includes an Ethernet physical layer, a USB physical layer, a wakeup packet detection circuit configured to receive a wakeup packet from the Ethernet physical layer, and a standby power saving control circuit. The standby power saving control circuits selects a connection speed from the group including EEE, 10 Mbps, 100 Mbps, 1 Gbps and 10 Gbps, wherein the standby power saving control circuit is able to connect to a wakeup device at the selected connection speed, so that the USB system can enter an optimal power saving status while in a standby mode. The connection speeds are defined in the specification of IEEE 802.3az as 10BASE-T, 100BASE-TX, 1000BASE-T, 10GBASE-T, 1000BASE-KX, 10GBASE-KX4, 10GBASE-KR.

### BACKGROUND OF THE INVENTION

1. Technical Field

The present invention relates to a Universal Serial Bus device and method, and more particularly, to a Universal Serial Bus device and method for power management.

2. Background

A conventional Universal Serial Bus (“USB”) device connecting via an Ethernet physical layer would reduce their connection speed to 10 megabits per second (Mbps) while its system host is in a suspend mode. This allows the USB device to reduce power consumption and not to use the more power-consuming connection speeds of 100 Mbps, 1 gigabits per second (Gbps) or 10 Gbps in a standby mode or power saving mode. If a wakeup device supports the 10 Mbps connection speed, the USB device communicates with the wakeup device at 10 Mbps, and waits for a wakeup packet under the power saving mode. When the wakeup device sends a wakeup packet, the USB device is awakened and sends a wakeup signal to a system host through a data interface physical layer so as to wake up the system host such that the USB device and the system host may return to operation under a normal mode.

However, the above-mentioned technique does not take into account whether a wakeup device supports the 10 Mbps connection speed. If the wakeup device does not support an Ethernet connection speed of 10 Mbps, the USB device and the wakeup device cannot establish connection, which may run the risk of failure to wakeup the system host. Furthermore, the above-mentioned technique does not take into account that the EEE (Energy Efficient Ethernet) function, defined under the IEEE 802.3az specification, may set the Ethernet connection speed at the most power-efficient speed available, which could be even lower than the 10 Mbps connection speed.

FIG. 1 shows a block diagram of a USB system in prior art. Referring to FIG. 1, the USB system includes a USB device 10 and a system host 15. The USB device 10 includes an Ethernet physical layer 112, a data interface physical layer 131, a standby power saving circuit 18 and a wakeup packet detection circuit 19.

The USB device 10 connects to a wakeup device 16 through an Ethernet line 12. The wakeup device 16 includes an Ethernet physical layer 111 and a wakeup packet generation circuit 17. The USB device 10 connects to the system host 15 through a data interface bus 14. The system host 15 includes a data interface physical layer 132. When the system host 15 transmits a standby mode signal from the data interface bus 14 through the data interface physical layer 132 to the data interface physical layer 131 of the USB device 10, the standby power saving control circuit 18 selects the slowest connection speed from among the 10 Mbps, 100 Mbps, 1 Gbps and 10 Gbps, and through the Ethernet physical layer 112 connects from the Ethernet network line 12 to the Ethernet physical layer 111 of the wakeup device 16. The selected connection speed serves as the Ethernet connection speed for the wakeup device 16 to wake up the USB device 10.

As to the wakeup procedure, the wakeup packet generation circuit 17 of the wakeup device 16 generates a wakeup packet, and sends the wakeup packet through the Ethernet physical layer 111, the Ethernet line 12 and the USB physical layer 112 of the USB device 10 to the wakeup packet detection circuit 19. Subsequently, a wakeup signal is sent through the data interface physical layer 131 and the data interface bus 14 to the data interface physical layer 132 of the system host 15, in order to wake up the system host 15.

When the system host 15 enters the standby mode, a power saving enable command 20 is transmitted through the USB physical layer 131 to the standby power saving control circuit 18. The wakeup device 16 transmits the wakeup packet through the Ethernet physical layer 112, and transmits Ethernet packet data 23 to the wakeup packet detection circuit 19. The wakeup packet detection circuit 19 transmits a wakeup signal 22 through the data interface physical layer 131, the data interface bus 14 and the data interface physical layer 132 to wake up the system host 15.

FIG. 2 shows a flow diagram of a power saving method for a USB device in the standby mode. Referring to FIG. 2, at Step S201, the USB device 10 receives a standby state signal of the system host 15, which is sent through the data interface bus 14 via the standby power saving control circuit 18 and the data interface physical layer 131.

At Step S202, the standby power saving control circuit 18 sets the Ethernet connection speed to 10 Mbps, and through the Ethernet physical layer 112 and the Ethernet line 12 informs the wakeup device 16 of the Ethernet speed set for the wakeup connection.

Next, at Step S203, the Ethernet communication is restarted at the set Ethernet connection speed.

At Step S204, it is determined whether the connection is successful. If the connection is not successful, the method returns to Step S203. If the connection is successful, the method proceeds to Step S205. At Step S205, the USB device 10 waits to receive the wakeup packet.

At Step S206, it is determined whether a correct wakeup packet is received. If the received wakeup packet is determined to be incorrect, the method returns to Step S205. If the received wakeup packet is determined to be correct, the method proceeds to Step S207. At Step S207, the wakeup signal is transmitted to the system host 15 in order to wake up the system host 15.

The above method may need to set an Ethernet connection speed to the slowest one. However, a compatibility issue associated with the Ethernet connect speed may arise because the Ethernet connection speed thus set may not be the most power-saving one.

Accordingly, it may be desirable to have a USB device that provides improvement over the prior art power-saving mechanism and takes into account the EEE function so as to achieve a more efficient power management in the standby mode.

### SUMMARY

The present invention discloses a USB device with a power-efficient function that comprises an Ethernet physical layer to communicate with a wakeup device; a USB physical layer to communicate with a host; and a control circuit, in response to a standby signal from the host, to select a first connection speed from a plurality of connection speeds to communicate with the wakeup device. The first connection speed is the most power-efficient one among the plurality of connection speeds. If the first connection speed is not compatible with the wakeup device, then the control circuit selects a second connection speed from the plurality of connection speeds to communicate with the wakeup device. The second connection speed is the second most power-efficient one among the plurality of connection speeds.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 shows a block diagram of a universal serial bus (USB) device in prior art;

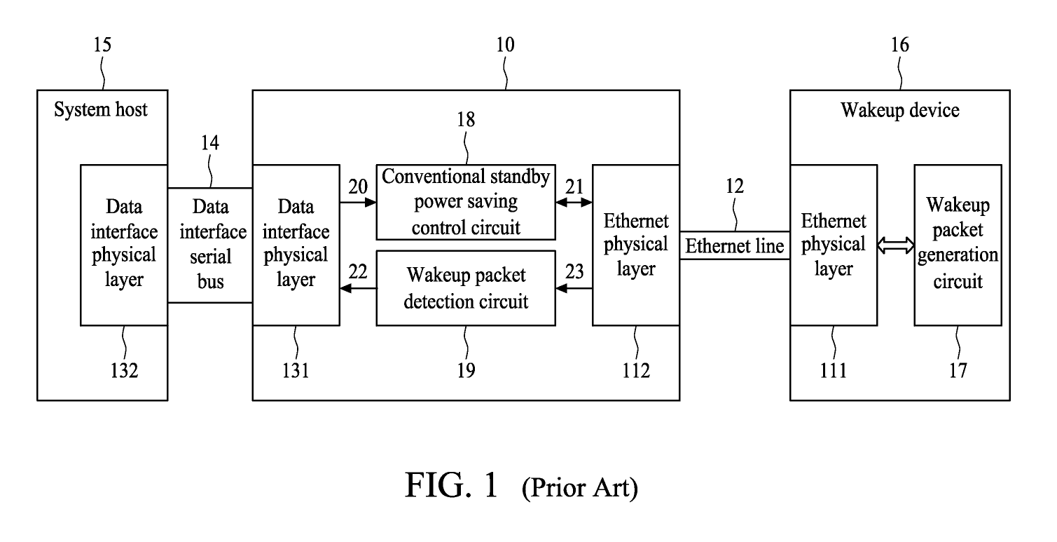

FIG. 2 shows a flow diagram of a wakeup packet detection circuit of FIG. 1;

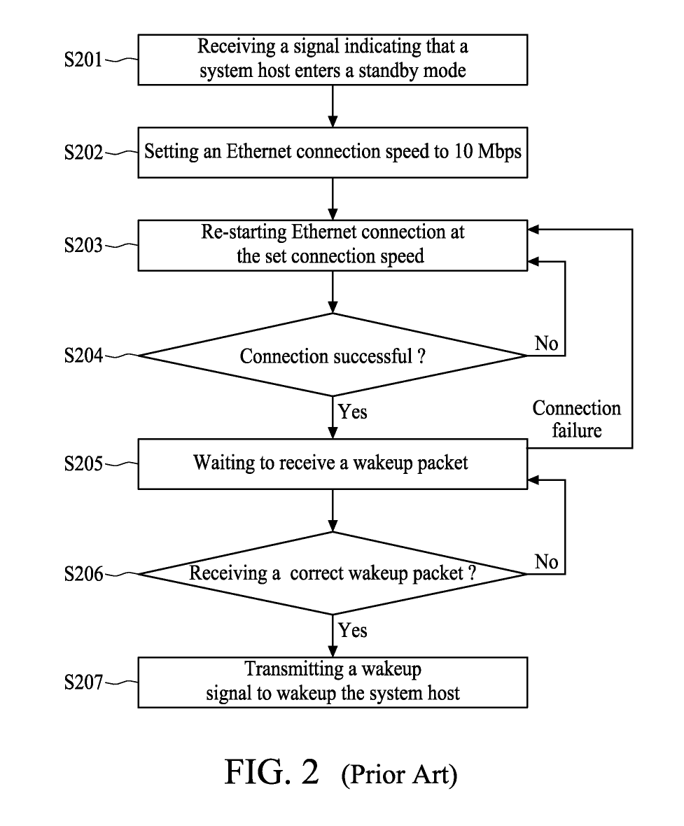

FIG. 3 shows a block diagram of a USB system according to one embodiment of the present invention;

FIG. 4 shows a block diagram of a standby power saving control circuit of FIG. 3; and

FIG. 5 shows a flow diagram of a method for the power saving control circuit of FIG. 4.

### DETAILED DESCRIPTION

The embodiments of the present invention are shown in the following description with the drawing, wherein similar or same components are shown with similar reference numbers.

The present invention provides a USB device with a standby power saving control circuit, wherein the power saving mechanism of the control circuit, while the USB device is in a standby mode, selects the most power-efficient connection speed to connect with a wakeup device. The method according to the embodiments of the present invention enables a USB device to consume less power than prior art methods while waiting for a wakeup packet.

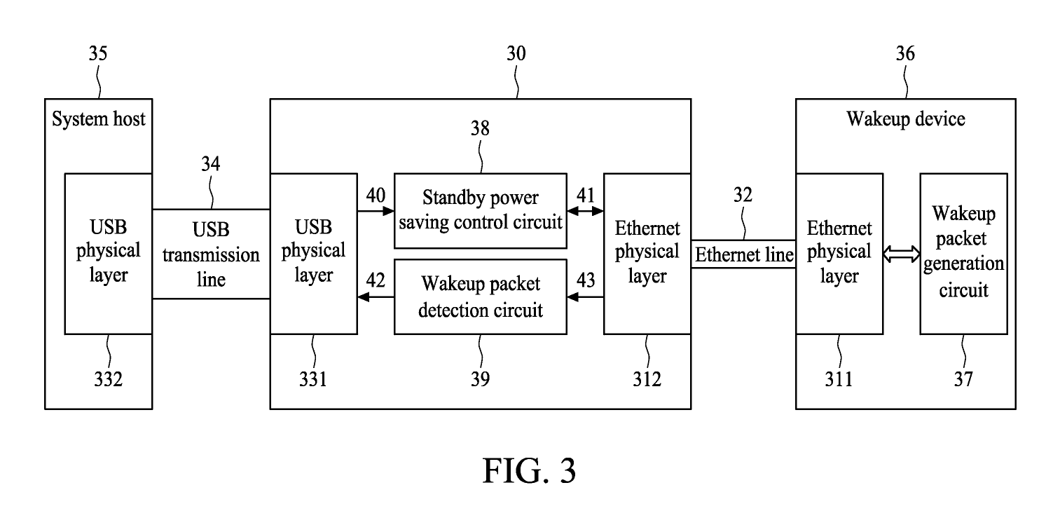

FIG. 3 shows a block diagram of a USB system according to one embodiment of the present invention. Referring to FIG. 3, the USB system includes a USB device 30 and a system host 35. The USB device 30 includes an Ethernet physical layer 312, a USB physical layer 331, a standby power saving control circuit 38 and a wakeup packet detection circuit 39.

The USB device 30 connects to a wakeup device 36 through an Ethernet line 32. The wakeup device 36 includes an Ethernet physical layer 311 and a wakeup packet generation circuit 37. The USB device 30 connects to the system host 35 through a USB transmission line 34. The system host 35 includes a USB physical layer 332, which serves as an interface communicating between the system host 35 and the USB device 30. When the system host 35 sends a standby mode signal though the USB physical layer 332 and a USB transmission line 34 to the USB physical layer 331 of the USB device 30, the standby power saving control circuit 38 selects the most power-efficient connection speed from among connectable speeds, such as 10 Mbps, 100 Mbps, 1 Gbps, EEE and 10 Gbps, for connection through the Ethernet physical layer 312 and the Ethernet line 32 to the Ethernet physical layer 331 of the wakeup device 36. The selected connection speed serves as the Ethernet connection speed of the wakeup device 36 to wake up the USB device 30.

A wakeup procedure is triggered by the wakeup packet generation circuit 37 of the wakeup device 36. The wakeup packet generation circuit 37 generates a wakeup packet and sends the wakeup packet through the Ethernet physical layer 311, the Ethernet line 32 and the Ethernet physical layer 312 of the USB device 30 to the wakeup packet detection circuit 39. In response to the wakeup packet, the wakeup packet detection circuit 39 generates a wakeup signal and sends the wakeup signal through the USB physical layer 331 and the USB transmission line 34 to the USB physical layer 332 of the system host 35 so as to wake up the system host 35.

When the USB physical layer 331 enters the standby mode, a standby signal, such as a power saving circuit enable command 40, is transmitted to the standby power saving control circuit 38. The standby power saving control circuit 38 connects to the Ethernet physical layer 312 through a communication interface 41.

The Ethernet physical layer 312 receives the wakeup packet of the wakeup device 36 and transmits an Ethernet packet data 43 to the wakeup packet detection circuit 39. The wakeup packet detection circuit 39 sends the wakeup signal 42 to the system host 35 through the USB physical layer 331.

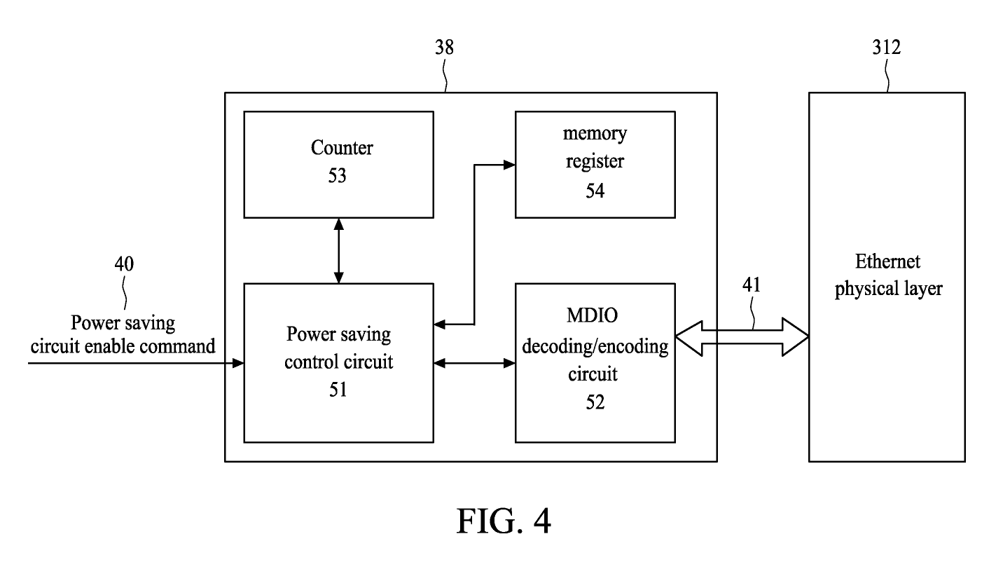

FIG. 4 shows a block diagram of the standby power saving control circuit 38. Referring to FIG. 4, the standby power saving control circuit 38 includes a power saving control circuit 51, a decode/encode circuit 52, a counter 53 and a memory register 54.

In response to the power saving circuit enable command 40, the power saving control circuit 51 selects the most power-efficient connection speed and sets, in conjunction with the decode/encode circuit 52, the most power-efficient connection speed as the Ethernet connection speed for connecting to the wakeup device 36. The counter 53 is used to calculate the power saving circuit enable command 40, and store the calculation procedure and the result in the memory register 54.

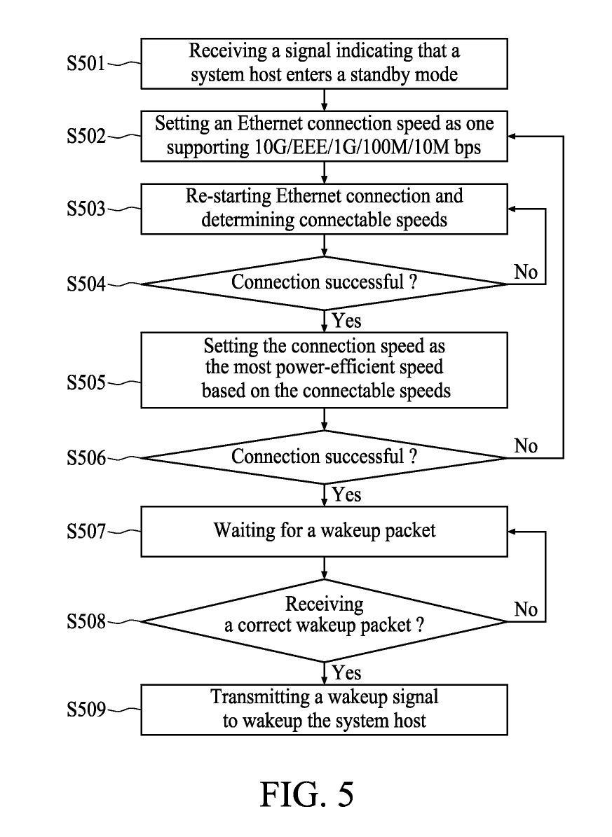

FIG. 5 shows a flow diagram of a method to determine the most-efficient operation of the USB standby mode according to one embodiment of the present invention. Referring to FIG. 5, at Step S501, the USB device 30 receives a standby signal from the system host 35, which is sent to the standby power saving control circuit 38 through the USB transmission line 34 and the USB physical layer 331.

At step 502, an Ethernet connection speed at the USB device side for Ethernet communication is set to one that supports transmission at a connectable speed, such as 10 Mbps, 100 Mbps, 1 Gbps, EEE or 10 Gbps. The Ethernet communication is to establish connection between the USB device 30 and the wakeup device 36.

At Step S503, the Ethernet connection is restarted to establish communication with the wakeup device 36 and to determine connectable speeds for the wakeup device 36.

Next, at Step S504, if the Ethernet connection at step S503 is successful, the method proceeds to Step S505. If the Ethernet connection is not successful, the method returns to Step S503 until a connectable speed is determined.

At Step S505, the communication speed of the USB device 30 is set to the most power-efficient connection speed based on the connectable speeds supported by the other side, i.e., the wakeup device 36.

At Step S506, it is determined whether the Ethernet connection at the most power-efficient speed is successful. If not successful, the method returns to Step S502 and the connection speed of the Ethernet is set to the second most power-efficient connection speed, which is selected from among 10 Mbps, 100 Mbps, 1 Gbps, EEE, and 10 Gbps.

At Step S507, the Ethernet physical layer 311 waits for a wakeup packet. When the Ethernet physical layer receives a wakeup packet, the method proceeds to Step S508.

Subsequently, at Step S508, the USB device 30 attempts to receive a correct wakeup packet. If the USB device 30 receives a correct wakeup packet, the USB device 30 is awakened, and the method proceeds to Step S509. If the USB device 30 does not receive a correct wakeup packet, the method returns to Step S507 and waits to receive another wakeup packet.

At Step S509, the USB device 30 is awakened and sends a wakeup signal to wake up the system host 35.

The power saving mechanism of the standby power saving control circuit 38 communicates with the Ethernet physical layer 312 of the USB device 30 through the transmission interface 52, and sets the connection speed for Ethernet connection based on the priority of EEE>10 Mbps>100 Mbps>1 Gbps>10 Gbps. As a result, the wakeup device 36 and the Ethernet physical layer 312 of the USB device 30 will connect using the most power-efficient mode in order to minimize power consumption during the standby period of the USB device 30. Therefore, when the wakeup packet generation circuit 37 of the wakeup device 36 transmits a wakeup packet to the USB device 30, the system host 35 is awakened, and the system host 35 resumes transmitting data normally through the USB physical layer 331 and the USB device 30.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A Universal Serial Bus (“USB”) device with a power-saving function, comprising:
an Ethernet physical layer to communicate with a wakeup device;
a USB physical layer to communicate with a host; and
a control circuit, in response to a standby signal from the host, to select a first connection speed from among a plurality of connection speeds to communicate with the wakeup device, and if the first connection speed is not compatible with the wakeup device, to select a second connection speed from among the plurality of connection speeds to communicate with the wakeup device, wherein the first connection speed is more power-efficient than the second connection speed.

2. The USB device of claim 1, wherein the plurality of connection speeds comprise Energy Efficient Ethernet (EEE), 10 megabits per second (Mbps), 100 Mbps, 1 gigabits per second (Gbps) and 10 Gbps.

3. The USB device of claim 2, wherein the power efficiency priority of the plurality of connection speeds is: EEE>10 Mbps>100 Mbps>1 Gbps>10 Gbps.

4. The USB device of claim 1, wherein the first connection speed is the most power-efficient among the plurality of connection speeds, and the second connection speed is the second most power-efficient among the plurality of connection speeds.

5. The USB device of claim 1, wherein the control circuit is configured to connect with the wakeup device using the first connection speed, and if the connection between the control circuit and the wakeup device is unsuccessful, the control circuit connects with the wakeup device using the second connection speed.

6. The USB device of claim 1, further comprising a detection circuit, wherein the detection circuit, in response to a wakeup packet from the wakeup device, generates a wakeup signal to wake up the host.

7. A method of power management for a USB device and a host, the method comprising:
receiving a standby signal from the host;
selecting a first connection speed from among a plurality of connection speeds and communicating with a wakeup device;
determining whether the first connection speed is compatible with the wakeup device; and
if the first connection speed is not compatible with the wakeup device, selecting a second connection speed from among the plurality of connection speeds and communicating the wakeup device, wherein the first connection speed is more power-efficient than the second connection speed.

8. The method of claim 7, wherein the plurality of connection speeds comprise EEE, 10 Mbps, 100 Mbps, 1 Gbps and 10 Gbps.

9. The method of claim 8, wherein the power efficiency priority of the plurality of connection speeds is: EEE>10 Mbps>100 Mbps>1 Gbps>10 Gbps.

10. The method of claim 7, wherein the first connection speed is the most power-efficient connection speed of the plurality of connection speeds, and the second connection speed is the second most power-efficient connection speed of the plurality of connection speeds.

11. The method of claim 7, wherein the step of determining whether the first connection speed is compatible with the wakeup device comprises:
connecting to the wakeup device using the first connection speed; and
selecting the second connection speed if the connection using the first connection speed fails.

12. The method of claim 7, further comprising the step of:
generating a wakeup signal to wake up the host in response to receiving a wakeup packet from the wakeup device.
